(19) United States
(12) Patent Application Publication
(10) Pub. No.: US 2005/0114549 A1
(43) Pub. Date: May 26, 2005

(54) Mechanism for extensible binary mappings for adaptable hardware/software interfaces

(76) Inventors: David M. Durham, Hillsboro, OR (US); Pankaj N. Parmar, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/723,052

(22) Filed: Nov. 26, 2003

(51) Int. Cl. G06F 15/16

(52) U.S. Cl. 709/246; 709/250

(57) ABSTRACT

An extensible definition of data exchanged between logical layered components of different platform hardware interfaces for management, configuration, and alerts and systems and methods for using same is disclosed. One embodiment is a mechanism for self-describing hardware and firmware components. An embodiment of the present invention is a system and method relating to a binary data definition and generic parser mechanism which allows efficient and runtime extensible definition of data exchanged between logical layered components of different platform hardware interfaces for management/configuration/alerting as well as providing generic basic input-output system (“BIOS”) and firmware data formats.

### FIELD OF THE INVENTION

An embodiment of the present invention relates generally to computer systems and, more specifically, to an extensible definition of raw data formats exchanged between logical layered components of different platform hardware interfaces for management, configuration, and alerts and systems and methods for using same.

### BACKGROUND INFORMATION

Various mechanisms exist for communicating data among the layers of a computer system. With hardware to software, and firmware to application software communication, a typical computer system has multiple layers of interfaces between these various layers. Current state of the art systems convert the data each time it passes to another layer using custom procedural code at each layer. The data traveling throughout the system is not commonly structured. One layer of the system has no knowledge of the data structure in any other layer of the system unless a driver is designed which understands how the hardware registers are organized and how they are configured. At each layer the system must transform the incoming and outgoing data, according to its usage. The data is transformed by copying it and/or data manipulation and through application programming interfaces (APIs), etc. This forced data manipulation is a fairly inefficient path up and down for hardware to kernel space and also for the applications above it.

### BRIEF DESCRIPTION OF THE DRAWINGS

The features and advantages of the present invention will become apparent from the following detailed description of the present invention in which:

FIG. 1 is a block diagram of a computing system with three logical layers showing communication among the layers for example layered components;

FIG. 2 is a table showing data definitions for data structures in an exemplary layered system;

FIG. 3 is a block diagram showing data type maps for exemplary structures in a system as disclosed herein;

FIG. 4 is a block diagram showing a buffer map and associated buffer holding data to be used by varying layers according to a system as disclosed herein;

FIG. 5 is block diagram showing an exemplary system for parsing data structures as defined by data structures in FIGS. 2 and 3;

FIG. 6 is a flow diagram of an exemplary parser as disclosed herein; and

FIG. 7 is a block diagram of an exemplary system having virtual machines with layered communications to a virtual network interface card.

### DETAILED DESCRIPTION

An embodiment of the present invention is a system and method relating to a binary data definition and generic parser mechanism which allows efficient and runtime extensible definition of data exchanged between logical layered components of different platform hardware interfaces for management/configuration/alerting as well as providing generic BIOS and firmware interfaces.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

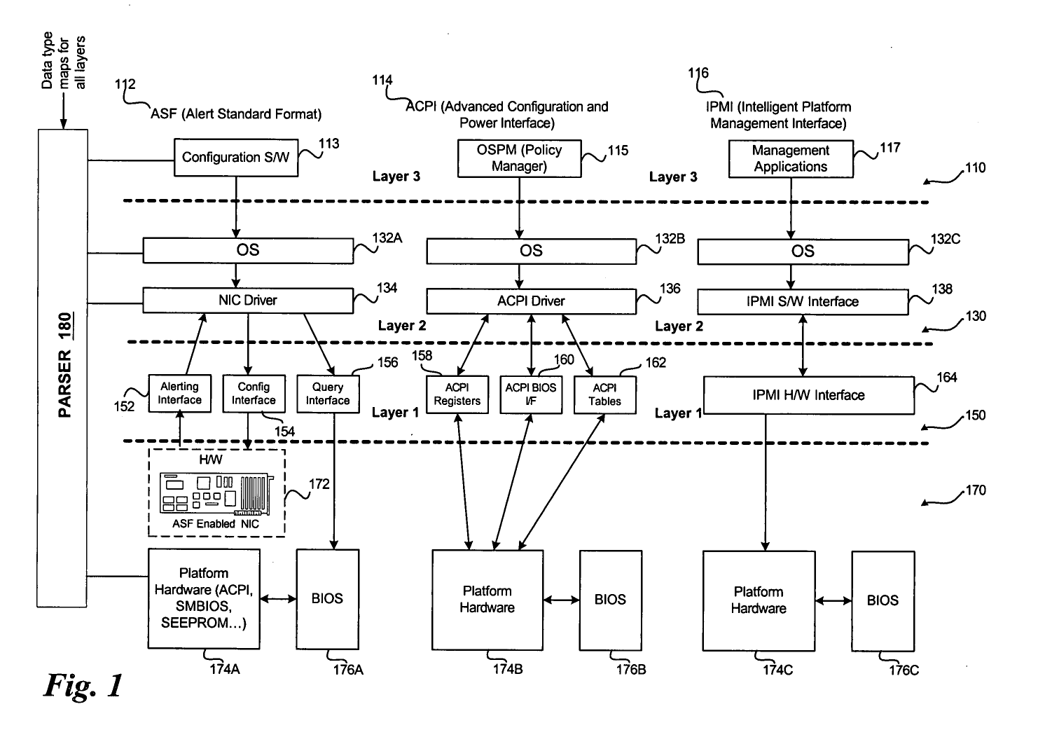

FIG. 1 shows multiple layers of different platform hardware standards. In at least one embodiment, the present invention is intended to insert a binary parser mechanism that uses maps and other structures decoupled from the actual data to create a generic description of the format and syntax of the data such that it can be manipulated by generic parser functions. It allows the manipulation of buffers in place and conversion of data to different formats in-line. Instead of writing specialized software to deal with data structures that come out of hardware and firmware, generic parsers are written where the hardware and firmware provide a map of their data to the parser and the software that receives the data from the parser provides a map of the expected data and then the parser manipulates the received data. The parser basically provides the data to the next layer in the stack. There are a number of mechanisms defined to manipulate data, i.e., network to host byte ordering, pointer adjustment, in-line across memory boundaries, etc. One feature of this method is that there are no buffer copies required. Likewise, all of the interfaces between the various layers are generic, and all forms of data can be handled by the parser mechanism.

FIG. 1 depicts the layered design of a few platform hardware interfaces. Dark dotted lines in FIG. 1 indicate the layer demarcations. Each layer receives data from the layer below it on a query operation or receives data from the layer above it during configuration. Each layer also maintains local data structures for storing data that it cares about and has the knowledge of the data structure that is understood by the layer above or below it. In systems of the prior art, before initiating any data transfer operation between layers, data needs to be copied from the layer local data structures to the data structures understood by the layer below or above it. The copy function involves element by element copying from source to destination data structures. Each layer essentially modifies the data it receives from the layer above or below it by filtering out some data elements, transforming it, and adding a few new ones prior to passing it on to the layer above or below it. Again, different data structures and data copy functions are defined for data being exchanged in either direction (up or down). The disadvantages of this kind of approach are evident: 1) highly overlapping redundant data structures 2) excessive data copying from one format to another 3) lack of runtime extensibility due to hard coded data structures and data manipulation logic.

The embodiments of a data exchange mechanism described herein may address shortcomings of the existing methods. Embodiments of the system and method allow multiple levels of interaction where intermediate layers can parse and store the base data types without understanding the complex high-level structures. Buffers can be directly converted to C structures or register transfer language (RTL) defined registers and yet be fully specified in terms of known base data types. A goal in implementation is not to re-invent a new language for defining data structures, but use existing languages like C and RTL aided by intermediate general purpose parser mechanisms.

Referring to FIG. 1, the three layers of abstraction 110, 130, and 150 are shown for three different platform standards: Alert Standard format (ASF) 112, Advanced Configuration & Power Interface (ACPI) 114, and Intelligent Platform Management Interface (IPMI) 116. Layer 3 (110) comprises software applications for each example: configuration software 113 for ASF; Operating System Policy Manager (OSPM) 115 for ACPI; and management applications 117 for IPMI. Layer 2 (130) comprises the operating system (OS) 132 for the system and an appropriate driver for the example: network interface card (NIC) driver 134; ACPI driver 136; and IPMI software interface 138. Layer 1 (150) is the layer adjacent to the hardware and firmware layer 170.

In one embodiment, a NIC allows the system to communicate over a network. For the NIC example, Layer 1 comprises an alerting interface 152; a configuration interface 154; and a query interface 156. The ASF enabled NIC 172 sends data to the alerting interface 152 and receives data from the configuration interface 154. The query interface 156 communicates with the basic input/output system (BIOS) 176A. Initialization, predominately, though BIOS created data structures are also used to enumerate devices in the system. The BIOS 176A is in communication with some of the platform hardware 174A. In this specific example, the BIOS also tells the query interface that the NIC is ASF capable.

ACPI is a standard for platform configuration and power management. In another embodiment, an ACPI driver 136 communicates with Layer 1. Layer 1 comprises ACPI registers 158; ACPI basic input-output system (“BIOS”) interface 160; and ACPI tables 162. Layer 1 of this embodiment communicates to the platform hardware 174B, which is initialized by the BIOS 176B.

IPMI enables remote and local management of a server. In another embodiment, Layer 1 comprises an IPMI hardware interface 164. The IPMI hardware interface 164 communicates with the platform hardware 174B, and the platform hardware 174C is initialized by the BIOS 176C.

Traditionally, each time data is passed between layers, it is copied, transformed or re-accessed. The present system and method does not change the layers; information flow between the layers is changed. Each layer has its own data structure defined and related software must be compiled separately with respect to binaries for each layer. In one embodiment, a common parser 180 is added to the layer structure to sit across all layers. Each layer has a data map for its required data. In one embodiment, a common data buffer flows from top to bottom of the layers, allowing each layer to interpret, or extract the required data, based on the layer's data map of the data buffer. In one embodiment, a common data buffer resides in system memory. The data buffer can be copied and sent over a network or other boundary. The common data buffer does not have to define local data structures used at each layer. The common data buffer contains the required data. A corresponding abstraction of the data, or data map, may either be included or be separate from the data buffer, and allows the layered components to access the data using their own data structure definitions.

Data buffers are defined similarly as they are today, i.e., with integers, bits, bytes, flags, other binary data, 32-bit integers (int32), pointers, short integers, floating point, etc. Data buffers do not need to be defined fundamentally different, but the corresponding data map needs to fully define which data types are part of the buffer. Mapping buffers, i.e., data maps, may be added to the actual data buffer. The data buffer may be a C structure, RTL (register transfer language) code, or other structure as necessary, to accommodate the programming language of choice. Further, data maps may be added to the actual data buffers, or communicated separately at the same time the data buffer is communicated or stored and later retrieved for interpreting the data buffer. In at least one embodiment, the data maps and the data buffer are fundamentally decoupled.

A generic parser 180 is added between, or across, the layers so that the individual layer can extract relevant data from the data buffer they receive. This is achieved with the help of maps and parsers. Parsers use data maps to interpret and extract data from the data buffer. Each layer is programmed with data maps and calls into a parser component to extract data. Because data maps can be changed dynamically at runtime, this approach is extensible.

Components/terminology used herein for one or more embodiments is described below:

According to one embodiment, “buffers” may include blocks of memory-transported between layers. Buffers may map directly to in-memory data structures as defined by C, RTL (for hardware registers) and/or assembly language.

According to one embodiment, a “buffer map” or “data map” may define the contents of a data buffer in terms of the type or types of data structures and their associated size or sizes corresponding to the data in the decoupled data buffer described above. The information may consist of the data type ID and length.

According to one embodiment, a “data type map” may define data structures in terms of base types and other derived types. A data type map may describe derived and structured types all the way down to their component base data types. Each data type may be a 32 bit integer that includes both base types and derived/constructed types. Types may be identified using 128 bit GUIDs as well, or any other means of data type identification. Each contained data type within a data structure type needs a DATATYPEMAP as well so that every base data type can be determined without knowledge of the structured data.

In one embodiment, a “memory map” may be used to identify instances of the data structures between layers. These addresses may be 32 bit local memory pointers that are translated across layer boundaries and updated to the new memory address space using a hash table that maps the old values to the new values. A pointer encoded in the buffer may be an inline pointer (pointing to the offset of the memory buffer location), or it may be an associative pointer, in which case it refers to an instance of a structure identified by a previous (or current) memory map location. Inline pointers are a special case of pointer used to identify variable length structures such as strings (variable character arrays), and are always interpreted as an offset relative to the start of the buffer.

In some embodiments, the generic parser 180 receives a data map from the hardware, for instance, in an option-ROM, or from a third party agent. The data map defines the contents of the common data buffer and how it is to be parsed. The data buffer is a block of data transported between layers, either explicitly, or through memory or data storage. The data buffer may map directly to in-memory data structures. In some embodiments, the data buffer may be swapped to a disk drive.

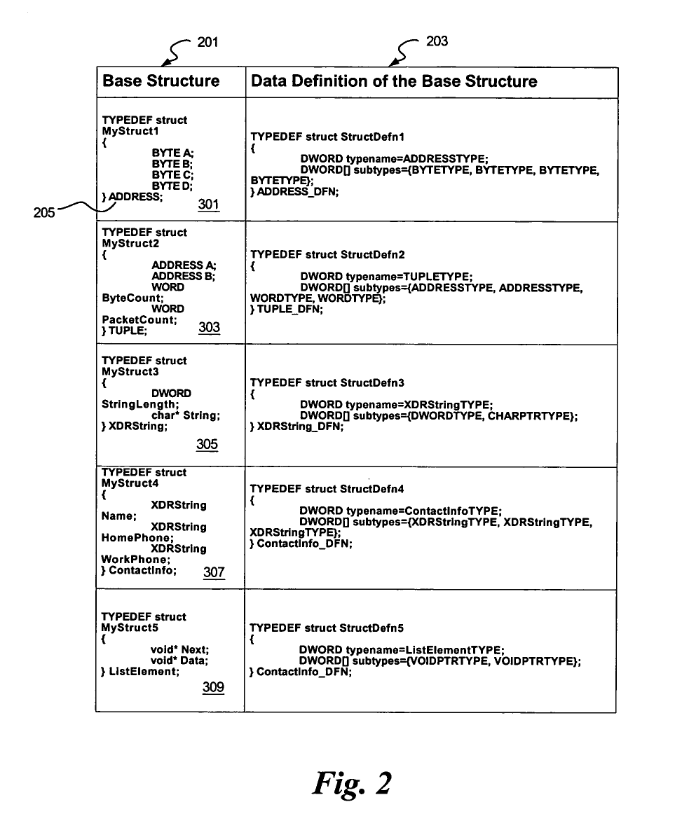

Referring now to FIG. 2, there are shown example data structures and their respective definitions. For this example, the data definition structures are shown defined in C. It will be apparent to one of ordinary skill in the art that the data structures could be defined in RTL or any other appropriate language. Column 201 shows the base structure for a given structure. Column 203 shows the data definition for the associated structure. For example, an ADDRESS base structure 205 comprises four bytes, and has a data definition which defines an ADDRESSTYPE, with the semantics of a network address, as having the syntax of a DWORD (four byte data structure).

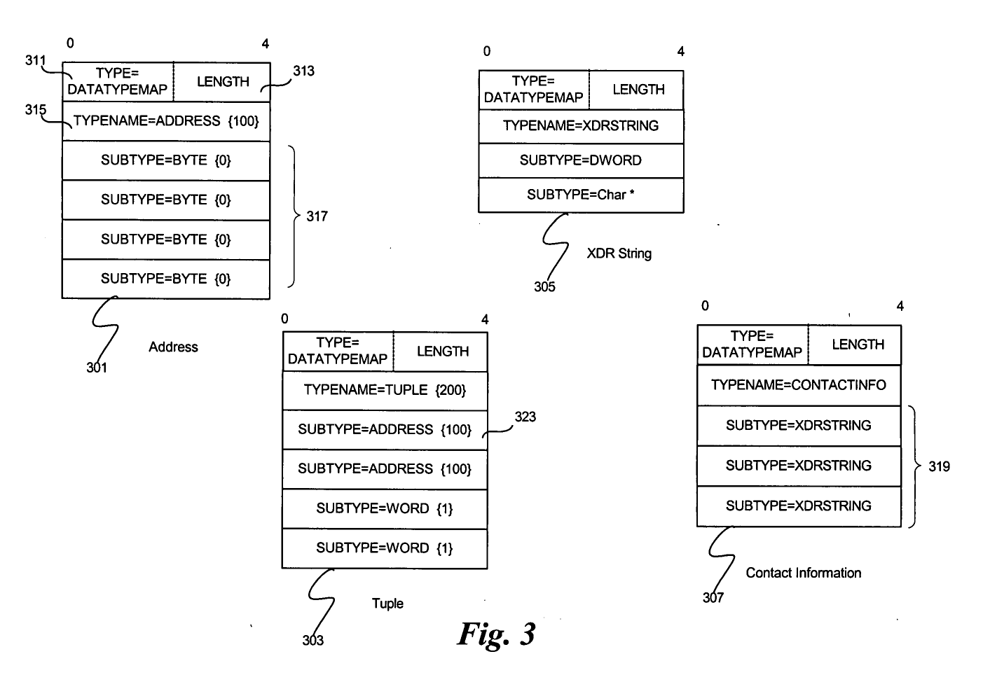

The parser parses data buffers passed between layers using data type map, buffer map and memory map information to interpret the data. The parser determines the derived data types of the instances of data in the data buffer using the buffer map. The parser then determines the base type structure of the derived types specific in the buffer map from the data type map. Examples of data type maps are shown in FIG. 3. Referring now to FIG. 3, a data type map for the derived structures ADDRESS 301, TUPLE 303, XDRSTRING 305 and CONTACTINFO 307 are shown. The data type map structure has a type field 311 indicating that it is a DATATYPEMAP. The length of the structure is identified in a field 313. The structure base type is indicated in field 315. The associated data fields are indicated by the byte subtypes 317. A structure may contain other base structures. For example, the CONTACTINFO data type 307 includes subtypes 319 of type XDRSTRING 305. In one embodiment, the fields of the DATATYPEMAP are predefined as specific codes. For example, in one embodiment using the structures of FIG. 3, the following table may be used to decode the fields of the data type map.

| English | | Contained | |
|---|---|---|---|
| Name | Type ID | Types | Size |
| BYTE | 0 | Base Type | 8 bits |
| WORD | 1 | Base Type | 16 bits |
| ADDRESS | 100 | BYTE, | 4 × BYTE |
| | | BYTE, | size |
| | | BYTE, | |
| | | BYTE | |
| TUPLE | 200 | WORD, | WORD size + |
| | | ADDRESS | ADDRESS |
| | | | size |

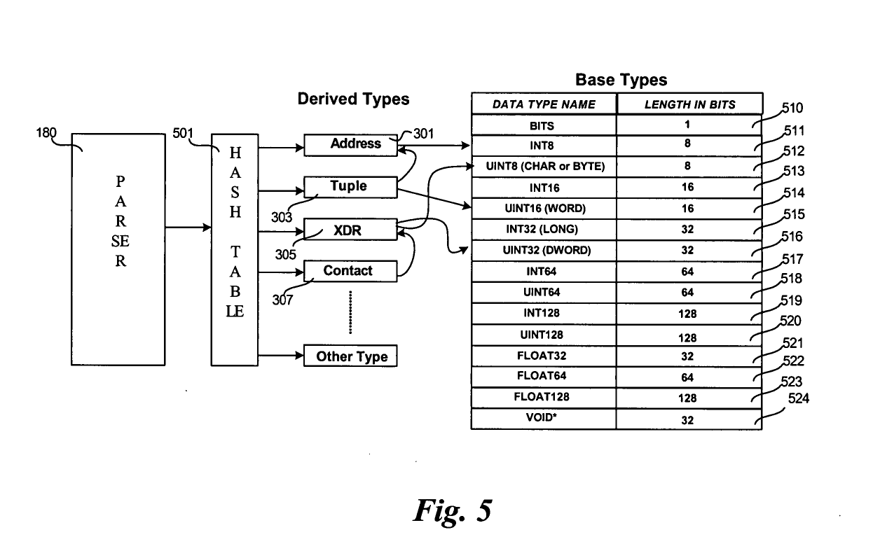

When the parser sees ID code 200, for instance, it knows that the structure contains a TUPLE structure. The TUPLE structure ID 200 decomposes into two contained types, the first is an INT16 base type and the other is a composite ADDRESS type. The ADDRESS type is composed of four BYTES, which are the base types representing the end of the search as they contain no more derived types. At this point the TUPLE structure has been decomposed entirely to its base data types, and the format of the portion of the data buffer corresponding to the TUPLE type is known down to the base types. Furthermore, the size of the TUPLE portion of the data buffer is also known as all the contained base types and their sizes are known. In FIG. 5, the parser is supplied with two tables, one for the derived data type IDs and one for the base data type IDs, and a hash table to expedite the data type ID searches. Derived types commonly encapsulate data members of other derived types in a recursive manner. This means data type ID searches are going to be recursive in nature. To expedite recursive searches and to accommodate for a large set of derived data type IDs, the parser depends on a hash table.

The parser determines base type information from the Data Type Map, determines associative memory associations from the Memory Map and determines buffer contents from the buffer map. The parser may perform useful generic functions such as inline and associative pointer updates (when moving from inline buffer offsets to absolute memory addresses), to reconstruction of the buffer into memory (allocating of the corresponding data structures and then copying of the buffer components into these), to validation of the data structures (type checking, string length checking, etc.). Other functions may include network to host byte ordering of base data types and vice versa for communication of the buffer over a network as well as data archival and routing between external processes. Specific helper macros may be written to perform data interpretation and summarization as well (such as adding up all the byte counts seen in the buffer conditional on the address fields). In one embodiment, the data structures may be updated yet the helper functions need not change. This is true when new data is only be appended to the end of existing data structures when updating them, allowing the parsers to map back to their layer's older version of the data structures.

The buffer map defines the buffer in terms of the types of data instances that it contains. The buffer map, or data map, defines how many fields there are in the buffer and their data types. The hardware may provide its own exchange of this, basically control structures, or what it is that is being sent. Since the buffer map is a separate data structure, the control block of data types may come from an external source (external to the hardware), such as from firmware that knows about the hardware, or option-ROM. The firmware would not have the data, but may have the data type map and/or buffer map.

The data type map defines data structures in terms of data types and derived types, base types defined that are referred to by the buffer map. The Buffer map defines the contents of the buffers in terms of the highest level of types. The buffer map will map the data buffer to different types of data. The types of data are defined in the Data type map.

Data buffers may be instance-data-driven. A data buffer may have different data types in it. When a data buffer is sent, the Buffer Map may be sent with the data buffer, so the receiving layer will know what that particular instance of the data looks like. It is a basically a snapshot. If the exchanged data buffers are of a fixed format, then the buffer map need only be read once at initialization time and can apply to all subsequent data buffers exchanged. In one embodiment, the data type map and buffer map need only be read once at initialization time.

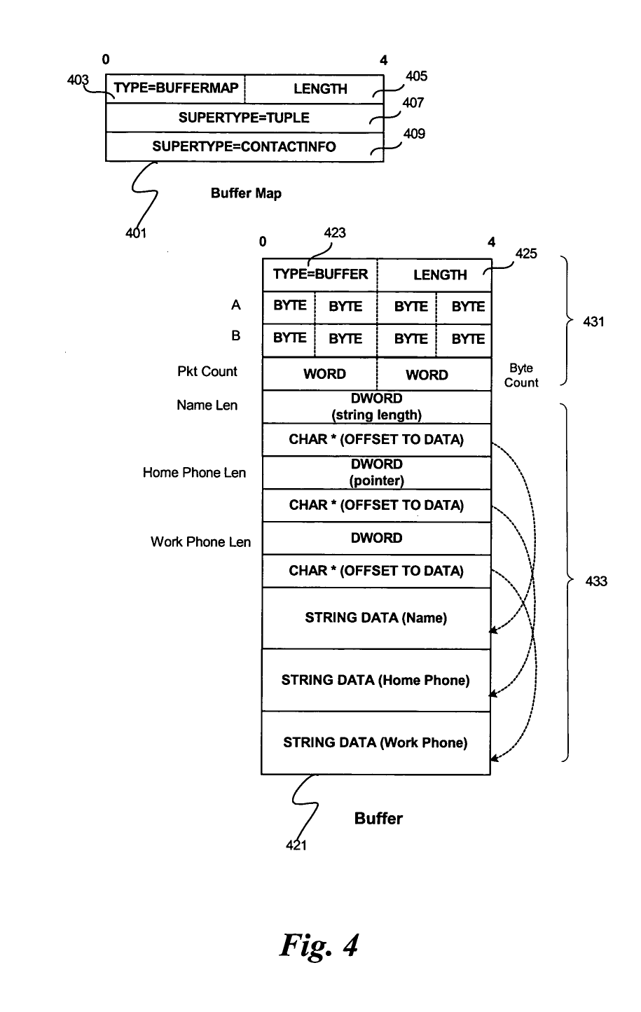

Referring to FIG. 4, there is shown a representation of an exemplary buffer map 401 and associated data buffer 421, according to one embodiment. Buffer maps, and data buffers are sent as data packets. Each data packet accessed by a layer has a type. Each data packet has a header which indicates its type 403, 423 and its length 405, 425. The associated data follows. A Buffer Map is of type BUFFERMAP 403. The associated buffer is of type BUFFER 423. The example buffer map 401 has a supertpye of TUPLE 407 and also a Supertype of CONTACTINFO 409. CONTACTINFO is a structure which is defined in the data map. (See FIG. 3, 307). CONTACTINFO has subtypes of XDRSTRING 305, XDRSTRING 305 and XDRSTRING 305. The Buffer map defines how the buffer is organized. If all buffers look the same, then only one buffer map needs to be sent to the layers. Otherwise, a buffer map may be sent with each buffer.

In this example, there are five different kinds of data structures: (1) ADDRESS 301; (2) TUPLE 303; (3) XDRSTRING 305; (4) CONTACTINFO 307; and (5) LISTELEMENT 309. The structures map to data types, as shown in FIGS. 2 and 3. FIG. 2 shows the structure of the data and FIG. 3 shows a representation of the same data type structure with the data type map header (i.e., type and length).

A TUPLE 303 for instance, has derived structure as part of it: ADDRESS 323. ADDRESS type 301 is not a base type, but comprises four BYTEs 317. BYTE is a base type as defined in the data type map (FIG. 5). To fully parse a TUPLE 303, ADRRESS data type 301 must also be parsed.

Referring now to FIG. 5, there is shown the correlation among the parser 180 and various data types and maps. In one embodiment, the parser 180 uses a hash table 501 to parse through the derived types 301, 303, 305, 307 in order to determine the base types 510-524 of the data. In an exemplary embodiment, base types include: BITS 510, INT8 511, UINT8 512, INT16 513, UINT16 514, INT32 515, UINT32 516, INT64 517, UINT64 518, INT128 519, UINT128 520, FLOAT32 521, FLOAT64 522, FLOAT128 523, and void * 524. In some languages, other base type names are used for similar or identical constructs. For instance LONG is an INT32, WORD is an UINT16, DWORD is a UINT32, CHAR and BYTE are UINT8. INTxx types typically use 2's compliment math.

Referring again to FIG. 4, the buffer map 401 has a type field 403, a length field 405, and supertypes 407 and 409. The example buffer map comprises derived type TUPLE 407 and CONTACTINFO 409 structures. The example buffer 421 that is read or interpreted by each layer is also shown. The buffer header identifies the block as being a data buffer 423 and has an associated length 425. The data structure that follows holds a TUPLE structure 431 and a CONTACTINFO structure 433. The data structure is shown in its base type form. For instance, the TUPLE 303 portion of the buffer 431 comprises two structures of ADDRESS and two structures of WORD. In this exemplary embodiment, this translates to two sets of 4 bytes and one set of 2 words. The CONTACTINFO portion 433 of the buffer comprises three XDRSTRING structures. These structures are also shown in their base type form in FIG. 4.

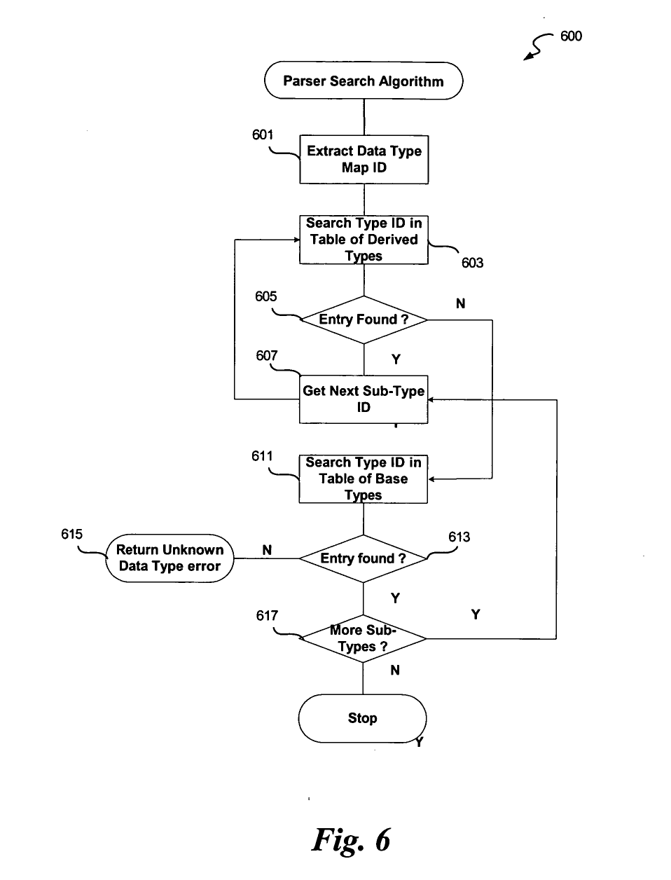

FIG. 6 is a flow chart of an exemplary algorithm 600 for parsing a buffer of data. When a layer needs data which is provided by another layer it may use this exemplary algorithm to parse the data buffer and extract (or load) the required data. The parser has access to a table of base and derived type identifiers. The data type map identifier for the buffer is extracted in block 601. A table of derived data types is searched for the extracted type identifier in block 603. If the entry is found, as determined in decision block 605, then a next subtype identifier is retrieved in block 607. The data type map is parsed to determine whether there are additional derived types. If the data type identifier is not found in the table of derived types, then the table of base types is searched for the identifier in block 611. If the entry is not found, as determined in decision block 613, then an error has occurred and appropriate action is performed in block 615. If the entry is found then a determination is made as to whether there are additional subtypes in decision block 617. If not, then parsing is complete down to the base type for all structures within the buffer. If there are more subtypes, then the next subtype identifier is retrieved in block 607 and parsing continues.

It will be apparent to one of ordinary skill in the art that base types may include additional types or fewer types. The base types may be defined to conveniently align with a target programming language and word length of selected hardware. Derived types may be defined for virtually any data structure that is to be used by software on various layers of the computing system. It will also be apparent to one of ordinary skill in the art that the base and derived data tables may be in various forms and stored in system memory, flash memory or any storage medium to which the computing system has access. It will also be apparent to one of ordinary skill in the art that the parsing mechanism as described herein may be the sole communication method used among the various layers, or it may be combined with legacy methods of buffer copying or data transformation/conversion. For example, a buffer map may be provided for some hardware and/or firmware and allow easy communication via a common data buffer, while other system hardware requires hardcoded drivers and buffer copies.

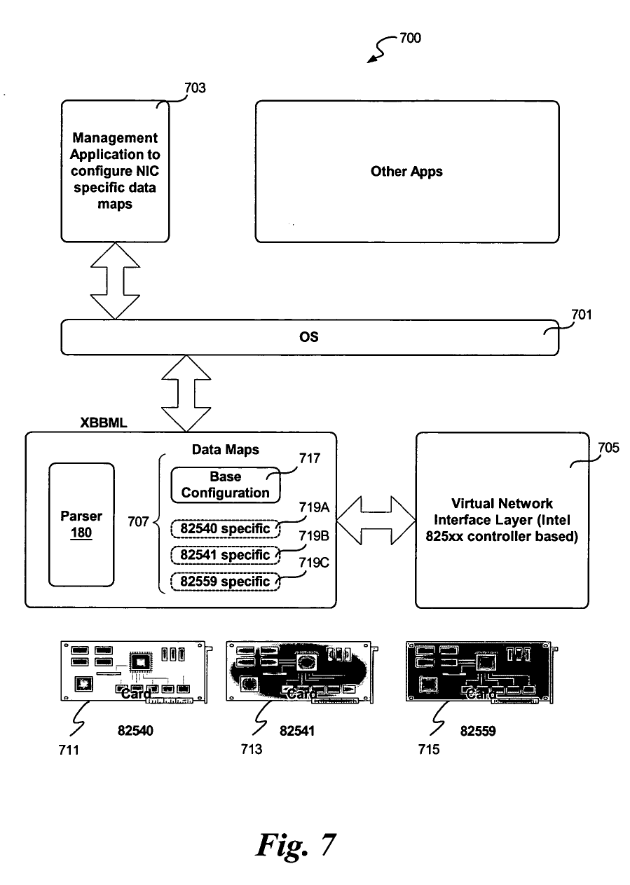

An exemplary environment that might use the disclosed system and method is a virtual machine having a network interface card. FIG. 7 shows an exemplary computer system 700 with a virtual machine using the disclosed method. An Operating system (OS) 701 may communicate with a management application 703 to configure the NIC-specific data maps. Data maps 707 may be loaded for several models of NICs, i.e., based in different Ethernet controller families, such as 82540 (711), 82541 (713), and 82559 (715). The virtual network interface layer 705 uses a virtual driver which maps to a hypothetical NIC. In systems of the prior art, a new driver was needed each time the physical NIC was changed in order to translate the virtual network card driver into commands that would actually communicate with the hardware. The applications running on the virtual machine would use the virtual driver and then be translated to the physical driver.

With the use of the disclosed parser 180, the virtual NIC driver does not need to communicate with custom drivers for the actual hardware. If the NIC hardware is changed, the parser need only be sent the appropriate data map for the installed NIC. The parser intercepts the communication from the virtual NIC driver and correctly interprets the data. Thus, when new NICs are developed and deployed, new drivers are not necessary. A new data map is developed and provided to the system instead.

In an exemplary computing system 700 with virtual machines (VMs), the Layer called VNIC, or virtual NIC layer, 705 does mapping of translations. The real hardware is hidden. Currently, there is a large family of Ethernet controllers, such as 82540, 82541, and 82559 available from Intel Corporation. There is not much difference among these controllers. Thus, to develop custom translations, a base configuration 717 is defined that is common to all possible Ethernet controllers and then specifics for each controller 719 are determined. If the system has an 82540 based NIC (711), but the VM must always show a 82557 based NIC (not shown) then a buffer map which contains differences (for, e.g., additional registers, packet buffer structure, etc.) between the two (82447 and 82540) must be generated. The VNIC layer 705 uses the data map 707 to communicate back and forth with the NIC. This is a transformation example. Suppose that the application is looking to collect specifics. It either needs to know all the different instances of the NIC devices and what the data format of the packet counting is or, it can let the disclosed parser handle the transformation.

In one example, the NIC device has effectively communicated its packet counting register. The application software just wants to determine what the packet counting register is, generically. Thus, no matter what device is plugged into the system, the NIC identifies where in the buffers and control registers it is going to put a particular piece of information, which is the packet counter. The OS or Virtual machine manager (VMM) doesn't care what card is installed. If the required information is the packet count, then, the application can communicate with the parser which knows how to translate the data structures and can pull out the required data.

The VM knows its virtual NIC, but the physically installed NIC may change when needed. The virtualization layer hides the real hardware from the OS. The Virtualization layer does have to know about the real hardware. Specific registers must be set, and are not the same across all NICs. The parser knows which registers to use for the installed NIC because it has the Data maps and data structures that define the data buffer.

With the virtualization, the parser is part of the virtualization layer. The driver which maps the virtual drivers to the real drivers does not change, but uses a parser to determine the differences between the base configuration and the specifics of the particular hardware. For example, sending/receiving a packet or setting up a filter to say block packets from a particular host may be defined in the driver. No new hardware is needed to implement the disclosed method.

There is not much difference between the code base of the NICs 711, 713, 715, but in virtualization, one does not want things to change too much. Modification of the driver to operate with the parser eliminates the need to change the virtual driver each time the hardware changes.

Using the disclosed method, every time the hardware changes, the virtual driver is mapped to a physical driver for the new hardware. Hardware vendors do not need to change hardware, but need to provide a buffer map. Vendors do not need to provide drivers, but need to provide the specifics or the data maps so that the generic driver can map the data using the parser.

Referring again to FIG. 1, a NIC controller, or driver 134 is an example of how the parser is used. The configuration software 113 requests that a buffer be sent to the NIC 172 using a user interface. The buffer is stored in a common area. The OS calls the driver 134. The driver 134 writes to the NIC 172. Each layer gets/writes the data to/from a common buffer using the parser 180 to transform the data to the format needed.

In one embodiment the parser is common to call from each application in each layer, but need not be built in. The parser may be designed as a system service. In other embodiments, each layer may have its own parser. In one embodiment, the parser is not much more than a library, like a dynamic link library (.dll). Various instantiations of the library or raw parser code needs to be accessible to all levels, however. The code of the parser may be part of the BIOS, where the BIOS provides a parser service to other software modules.

In order to modify current systems to utilize the disclosed method, current drivers need to be modified to use a parser. If the current drivers can be reduced, for example, from 2 MB to 500 KB, then there is incentive to implement this approach; maintenance costs are lower for the hardware vendors as generic drivers need not change with hardware revisions and vice versa.

In some embodiments the parser performs the conversions for pointer manipulation. It may also transform host order of bytes to network order of bytes, like big endian and little endian transformation. For example, typically, a NIC driver makes function calls, i.e., ntohs(x) network to host or htonl(x) host to network long (4 bytes). The NIC driver expects the data to be in network order. The parser converts the host order to the network order.

The techniques described herein are not limited to any particular hardware or software configuration; they may find applicability in any computing, consumer electronics, or processing environment. The techniques may be implemented in hardware, software, firmware or a combination of all. The techniques may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, that may include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1. A system for a generic parser, comprising:
a parser communicatively coupled with layered components, the layered components requiring data passed between logical layers of a computing system for communication with platform hardware and platform firmware;
a data buffer having data communicated between the layered components, the data buffer having a data structure comprehensible to the parser; and
layered component drivers comprehending the data buffer after conversion by the parser.

2. The system as recited in claim 1, wherein the communicated data buffer is defined by a buffer map, the buffer map comprising a type field, a length field and at least one field defining data types corresponding to data in the communicated data buffer.

3. The system as recited in claim 2, wherein the buffer map corresponding to data buffer are communicated separately.

4. The system as recited in claim 2, wherein each field defining data types is one of a derived data type and base data type.

5. The system as recited in claim 4, wherein a derived data type comprises at least one of a derived data type and a base data type.

6. The system as recited in claim 4, wherein a common set of base data types are defined in terms of size, format and semantic meaning.

7. The system as recited in claim 2, wherein the parser uses a hash table to search a derived type table and base type table to fully comprehend the communicated data buffer in terms of contained data instances, their format and semantic meaning.

8. The system as recited in claim 1, wherein an in-line data byte order of the data buffer is transformed to and from big endian and little endian byte order.

9. The system as recited in claim 1, wherein pointers are converted in-line based on a new buffer base address.

10. The system as recited in claim 1, wherein pointers are converted in-line to new address space after crossing virtual memory boundaries.

11. The system as recited in claim 1, wherein data type translation is performed to comprehend the communicated data buffer between layered components.

12. The system as recited in claim 1, wherein conversion of data from one format into another is performed to comprehend the communicated data buffer between layered components.

13. The system as recited in claim 1, wherein transformation of data units is performed to comprehend the communicated data buffer between layered components.

14. The system as recited in claim 1, wherein data is scaled via mathematical transformation to comprehend the communicated data buffer between layered components.

15. A method for using a communicated data buffer among logical layered components in a computing system, comprising:
reading a unit of data from the communicated data buffer, by the parser, according to a buffer map;
determining a type associated with the unit of data;
if the unit of data type corresponds to a derived data type, then identifying data structures comprising the derived data type; and
communicating with at least one layered component, wherein the layered component requires access to a structure in the communicated data buffer.

16. The method as recited in claim 15, wherein the buffer map is communicated separately from the data buffer.

17. The method as recited in claim 15, wherein identifying data structures further comprises:
extracting a data type map identifier from the unit of data;
searching for the data type map identifier in a table of derived types; and
if the data type map identifier is not found in the table of derived types, then searching for the data type map identifier in a table of base types,
wherein extracting and searching continue until all data map identifiers in the data unit have been extracted to their base types.

18. The method as recited in claim 15, wherein if the unit of data type is a data buffer type, then extracting data from the communicated data buffer based on a data type map associated with the communicated data buffer.

19. The method as recited in claim 18, wherein the extracted data corresponds to a data structure required by the layered component.

20. The method as recited by claim 15, wherein the layered component is a virtual interface layer.

21. The method as recited by claim 20, wherein data type maps are defined for a plurality of hardware components, and wherein the parser enables the virtual interface layer to communicate with an existing hardware component.

22. The method as recited by claim 21, wherein the virtual interface layer publishes a hardware interface that does not correspond to a defined data type map, wherein a map is defined for translating the published hardware interface to data type comprehended by the parser.

23. The method as recited in claim 15, wherein an in-line data byte order of the data buffer is transformed to and from big endian and little endian byte order.

24. The method as recited in claim 15, wherein pointers are converted in-line based on a new buffer base address.

25. The method as recited in claim 15, wherein pointers are converted in-line to new address space after crossing virtual memory boundaries.

26. The method as recited in claim 15, wherein data type translation is performed to comprehend the communicated data buffer between layered components.

27. The method as recited in claim 15, wherein conversion of data from one format into another is performed to comprehend the communicated data buffer between layered components.

28. The method as recited in claim 15, wherein transformation of units of data is performed to comprehend the communicated data buffer between layered components.

29. The method as recited in claim 15, wherein data is scaled via mathematical transformation to comprehend the communicated data buffer between layered components.

30. An article of manufacture comprising a machine accessible medium containing code having instructions that, when executed during pre-boot, cause the machine to:
read a unit of data from the communicated data buffer, by a parser, according to a buffer map;
use a buffer map to determine data types contained within the communicated data buffer;
use a data type map to identify data structures contained within the communicated data buffer; and
communicate with at least one layered component, wherein the at least one layered component requires access to a structure in the communicated data buffer.

31. The article as recited in claim 30, wherein, the buffer map is communicated separately from the data buffer.

32. The article as recited in claim 30, wherein identifying data structures further comprises code causing the machine to:
extract a data type map identifier from the unit of data;
search for the data type map identifier in a table of derived types; and
if the data type map identifier is not found in the table of derived types, then search for the data type map identifier in a table of base types,
wherein extracting and searching continue until all data map identifiers in the data packet have been extracted to their base types.

33. The article as recited in claim 30, wherein if the data unit type is a data buffer type, then further comprising code with causes the machine to extract data from the communicated data buffer based on a data type map associated with the communicated data buffer.

34. The article as recited in claim 33, wherein the extracted data corresponds to a data structure required by the layered component.

35. The article as recited by claim 30, wherein the layered component is a virtual interface layer.

36. The article as recited by claim 35, wherein data type maps are defined for a plurality of hardware components, and wherein the parser enables the virtual interface layer to communicate with an existing hardware component.

37. The article as recited by claim 36, wherein the virtual interface layer publishes a hardware interface that does not correspond to a defined data type map.
